(19) United States
(12) Patent Application Publication
(10) Pub. No.: US 2012/0305309 A1
(43) Pub. Date: Dec. 6, 2012

(54) PREWIRED PULSE VALVE WIRING HARNESS WITH DIODES

(75) Inventor: Glenn S. Hanson, Knoxville, TN (US)

(73) Assignee: ALSTOM TECHNOLOGY LTD, Baden (CH)

(21) Appl. No.: 13/151,772

(22) Filed: Jun. 2, 2011

(51) Int. Cl. H01B 7/00

(52) U.S. Cl. 174/72 A; 174/71 R

(57) ABSTRACT

In accordance with the present inventive concept, there is provided a wiring harness. The wiring harness comprises a first supply conductor, a first and a second circuit return conductor, and a first plug connector comprising a first and a second output terminal. The supply conductor is connected to the first output terminal. Moreover, the first circuit return conductor is connected to the second output terminal via a first diode arranged in the plug connector, and the second circuit return conductor is connected to the second output terminal via a second opposing diode arranged in the plug connector. There is also provided a wiring circuit comprising a plurality of wiring harnesses.

### FIELD OF THE INVENTION

The present inventive concept generally relates to wiring harnesses. More specifically, the present inventive concept relates to wiring harnesses arranged to be connected to solenoid valves.

### BACKGROUND OF THE INVENTION

Dust collectors are used to remove pollutive elements, such as dust, dirt, particulates or the like, from polluted gases. During operation, streaming gas enters via an inlet duct of the dust collector and passes through a cleaning device. Thereafter, clean gas exits via an outlet duct of the dust collector which may be recycled or released into the ambient air.

Typically, the cleaning device comprises a plurality of filter elements which clean the streaming gas. Each filter element may for example be comprised of a cylindrical bag made out of a flexible medium, such as woven fabric of felt, or be comprised of a rigid medium, such as porous ceramic or a gravel bed. During operation, the polluted gas passes from the outside of the filter elements through the walls and into their interior, whereupon clean gas exits from the filter elements via a connection to their interior. The pollutive elements are collected at the outer surface of the filter elements and consequently form filter cakes. Thus, the filter elements must be cleaned occasionally. Each filter element may be cleaned separately or, alternatively, groups of filter elements may be cleaned simultaneously.

Thus, the filter cake formed around each filter element needs to be removed at certain time intervals. The cleaning may be performed during operation of the dust collectors or during shutdown of the same. As disclosed in U.S. Pat. No. 4,336,035, the filter element may be cleaned during operation by means of a whipping action. More specifically, a short compressed air pulse controlled by a solenoid valve, or a pulse valve, is injected into the filter element which causes it to undergo a rapid accelerating motion, thus momentarily stretching the filter element, and thereby removing the filter cake. The compressed air pulse is typically released from a valve which is arranged in direct communication with the filter element. After the filter cake has been cracked and has been released from the filter element, it falls gravitationally into a hopper where it can be collected and removed from the dust collector.

Commonly, the pressure, the frequency and the duration of the air pulses are varied in order to optimize the cleaning of the filter elements and also in order to maximize their life. For example, in US 2003/0089234, these parameters are optimized according to a certain algorithm in order to minimize the total emission of dust from the dust collector.

The solenoid valves controlling the air pulses are preferably in turn controlled by a pulse timer or other type of controller located in a control panel. The solenoid valves are connected to the controller directly at the control panel and/or via junction boxes. As mentioned above, the solenoid valves may be activated separately or in groups. In order to control a plurality of solenoid valves, one may utilize a multiplexing circuit. The multiplexing circuit utilizes diodes (one per solenoid for DC circuits and two per solenoid for AC circuits) in the return leg of the circuit. To accommodate the multiplexing, two opposing diodes (for AC circuits) are connected to the return path from the solenoid. After the two diodes, the return circuit is via two return paths. The diodes are located in the control panel or junction boxes for each group of solenoids.

The connections of circuits currently available require that each of the solenoid valve is connected to the control panel or junction box by means of a cord set or the like. A cord set of three conductors must be connected to each solenoid valve. The three conductors would provide the supply conductor, the return conductor and the ground conductor for each solenoid valve. Thus, for connecting a large number of solenoid valves, a corresponding large number of cord sets is needed together with a large number of junction boxes.

This extensive amount of wiring and material makes the installation of the solenoid valves to the control panel tedious and time-consuming. Moreover, the installation costs of this extensive wiring are generally high.

### SUMMARY OF THE INVENTION

It is therefore an object of the present invention to provide a wiring harness for simplifying and lowering the cost of the wiring of electronic devices, such as solenoid valves.

According to a first aspect of the invention, there is provided a wiring harness comprising a first supply conductor, a first and a second circuit return conductor and a first plug connector. The first plug connector comprises a first and a second output terminal. Moreover, the supply conductor is connected to the first output terminal. The first circuit return conductor is connected to the second output terminal via a first diode arranged in the plug connector, and the second circuit return conductor is connected to the second output terminal via a second opposing diode arranged in the plug connector.

An advantage of integrating a pair of diodes with the plug connector, is that there is a reduced amount of installation work needed, since the assemblage of the diodes is already provided for. More specifically, the assemblage of the wiring harness with other electronic units, such as solenoid valves, or pulse valves, and control panels, is simplified, in particular when assembling a large number of electric units.

An additional advantage of using the wiring harness according to the present inventive concept to connect to the electronic devices is that one wiring harness can connect to a plurality of electronic devices. By locating the diodes for each electronic device in the plug connector, the number of wires needed for the complete wiring harness is reduced because two return conductors and one ground conductor can serve the entire harness assembly that will accommodate a number of electronic devices. For example, if the wiring harness is designed for ten devices, a total of thirteen conductors would be required (ten supply conductors, two return conductors, and one ground conductor). If the diodes were located in the junction box instead on the plug connector, the wiring harness would require 21 conductors (ten supply conductors, ten return conductors and one ground conductor).

Note that the purpose of the pair of opposing diodes (or single diode for DC circuits) is to prevent the incorrect activation of electronic devices which may be connected in the circuit. The diodes prevent the backflow of current into other sub-circuits which may be connected to any of the circuit return conductors. This backflow of current would cause undesired activation of additional electronic devices, such as solenoid valves, comprised in these sub-circuits.

In more detail, the supply conductor on the circuit is arranged to deliver current (AC or DC) received from a power supply to the electronic device (solenoid valve). For the AC circuit, the positive pulse of the AC waveform passes through the first diode to the first return conductor and the negative pulse of the AC waveform passes through the second diode to the second return conductor. Since all the other diodes connected to the same return conductor are in a position opposed to the current flow, current flowing into additional sub-circuits is blocked. For a DC circuit, a single diode and return conductor would function in a similar fashion.

Yet another advantage with the present inventive concept is that the wiring harness may be prefabricated. Preferably, a prefabricated wiring harness is provided having a desired length, a desired number of plug connectors, a desired number of supply conductors, etc.

According to one embodiment, the wiring harness further comprises a ground conductor. The ground conductor may be connected to a third output terminal comprised in the plug connector. The third output terminal may in turn be arranged to be connected to an electronic device. Additionally, the ground conductor may be arranged to be connected to a control panel. An advantage of providing a ground conductor in the wiring harness is that it will become possible to address electric shock hazard concerns, i.e. to provide an electrical connection between non-current-carrying metallic parts of the electronic devices etc. connected to the wiring harness and the earth. Alternatively/additionally the ground conductor may act as a shield against electromagnetic interference.

According to one embodiment, the wiring harness further comprises a second supply conductor and a second plug connector. The second plug connector comprises a first and a second output terminal. The second supply conductor is connected to the first output terminal of the second plug connector. Moreover, the first circuit return conductor is connected to the second output terminal of the second plug connector via a first diode arranged in the second plug connector, and the second circuit return conductor is connected to the second output terminal of the second plug connector via a second opposing diode arranged in the second plug connector. The details and advantages of the embodiment comprising the first plug connector described above also apply to this embodiment. An additional advantage of this embodiment is that the number of wires needed for the installation is reduced. Additionally, the associated installation cost is diminished.

According to an alternative embodiment, the wiring harness further comprises a plurality of supply conductors and a plurality of plug connectors. Each plug connector comprises a first and a second output terminal. Each supply conductor is connected to the first output terminal of a plug connector. Moreover, the first circuit return conductor is connected to the second output terminal of each plug connector via a first diode arranged in each plug connector, and the second circuit return conductor is connected to the second output terminal of each plug connector via a second opposing diode arranged in each plug connector. The details and advantages of the embodiment comprising the first plug connector described above also applies to this embodiment. An additional advantage of this embodiment is that it is possible to attach a large amount of connectors to the wiring harness while keeping the number of connectors at a minimum.

According to one embodiment, the output terminals in each of the plug connectors are arranged to be connected to a respective electronic device. The electronic device may be a solenoid valve, a pulse valve, a switch, a relay, or the like. An advantage of this embodiment is that the electronic device may be easily connected without the need for soldering.

According to one embodiment, at least one electronic device is a solenoid valve. An advantage of this embodiment is that manufacture of a dust collector according to the above may be facilitated.

According to one embodiment, the first supply conductor terminates at the first plug connector, and the second supply conductor passes through the first plug connector and terminates at the second plug connector. An advantage of this embodiment is that the wiring harness is easy to manufacture. For example, to assemble the wiring harness, one may utilize existing junction boxes which allow for wires to be terminated or passed through.

According to a second aspect of the invention, there is provided a wiring circuit comprising a plurality of wiring harnesses. The plurality of harnesses are coupled in parallel such that the first supply conductor of each of said plurality of harnesses are jointly connected and the second supply conductor of each of said plurality of harnesses are jointly connected. Furthermore, the circuit return conductors of each of the plurality of harnesses are jointly connected.

The details and advantages of the first aspect also apply to the second aspect. As an additional advantage, due to the joint connection of each supply conductor, specific groups of electronic devices connected to the wiring harnesses may be activated substantially simultaneously. This simplifies an online operation of groups of electronic devices, as will be further elucidated below.

According to one embodiment, the wiring circuit is connected to a control unit for controlling a plurality of electronic devices. An advantage of this embodiment is that specific groups of electronic devices may be controlled by a one common control unit.

According to one embodiment, at least one of the plurality of electronic devices is a solenoid valve.

According to one embodiment, the control unit is arranged to provide AC pulses according to a predetermined scheme on each of the supply conductors. The predetermined scheme may comprise various characteristics of the AC pulse such as its timing, amplitude, form, duration, frequency, etc. An advantage of this embodiment is that groups of electronic devices connected to the wiring circuit may be controlled to a degree specific for each group.

Other features and advantages of embodiments of the present invention will become apparent to those skilled in the art upon review of the following drawings, the detailed description, and the appended claims.

### BRIEF DESCRIPTION OF THE DRAWINGS

The above, as well as additional objects, features and advantages of the present inventive concept, will be better understood through the following illustrative and non-limiting detailed description of preferred embodiments of the present inventive concept, with reference to the appended drawings, where like reference numerals will be used for like elements, wherein:

FIG. 1 schematically illustrates an embodiment of a wiring harness according to the present inventive concept coupled to four solenoid valves.

FIG. 2 is a schematic wiring layout of a wiring circuit according to the present inventive concept, wherein two sets of wiring harnesses are coupled to four solenoid valves.

FIG. 3 is a schematic wiring layout of a wiring circuit according to the present inventive concept comprising three wiring harnesses, each of which is coupled to four solenoid valves.

### DETAILED DESCRIPTION OF PREFERRED EMBODIMENTS

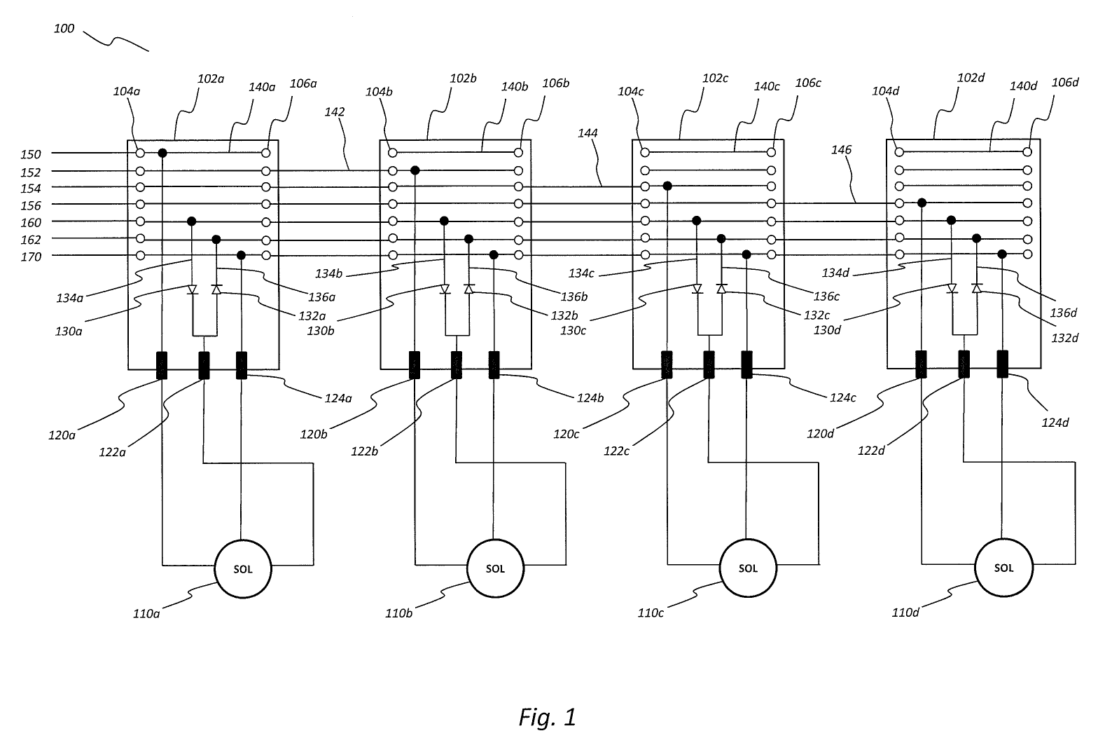

Initially referring to FIG. 1, which schematically illustrates an embodiment of a wiring harness 100, the wiring harness 100 comprises four plug connectors 102a-d which respectively are provided with seven input ports 104a-d and seven output ports 106a-d. Each of the input ports 104a-d comprised in the plug connectors is connected via an intermediate conductor 140a-d to a corresponding output port 106a-d in the same plug connector. Moreover, the plug connectors 102a-d are provided with first output terminals 120a-d, second output terminals 122a-d and third output terminals 124a-d. Each of the plug connectors 102a-d comprises a pair of diodes 130a-d and 132a-d. In the present embodiment, the diodes 130a-d and 132a-d share the same characteristics. In an alternative embodiment, some or all of the diodes 130a-d and 132a-d may be different.

Four of the input ports 104a of the first plug connector 102a are connected to supply conductors 150, 152, 154 and 156. Moreover, two of the input ports 104a are connected to a first 160 and a second 162 circuit return conductor. The remaining input port 104a is connected to a ground conductor 170.

The first output terminal 120a of the first plug connector is connected to the intermediate conductor 140a which is connected to the supply conductor 150. The output port 106a connected to the supply conductor 150 has no further connections. The remaining supply conductors 152, 154 and 156 are not directly connected to any output terminal of the first plug connector 102a. Moreover, the first 160 and the second 162 circuit return conductors are connected to the second output terminal 122a via the conductors 134a and 136a and a respective diode 130a and 132a (oppositely directed to the diode 130a) and via a respective intermediate conductor 140a. In a preferred embodiment two diodes are used since AC input signals, or equivalently, AC pulses, will be applied to the supply conductor 150 as will be described below. However, it is emphasized that for DC input signals only one diode and one return conductor would be used. The ground conductor 170 is connected to the third output terminal 124a via an intermediate conductor 140a.

Three of the input ports 104b of the second plug connector 102b are connected to the supply conductors 152, 154 and 156 via the wirings 142 and three output ports 106a of the first plug connector 102a. Moreover, two of the input ports 104b are connected to the first 160 and the second 162 circuit return conductor via the wirings 142 and two output ports 106a of the first plug connector 102a. One input port 104b is connected to the ground conductor 170 via a wiring 142 and an output port 106a of the first connector.

The internal connections in the second plug connector 102b between the input/output ports 104b, 106b and the output terminals 120b, 122b and 124b are principally analogous to those in the first plug connector 102a. In particular, one of the supply conductors 152 is connected to the first output terminal 120b of the second plug connector 102b, the first 160 and the second 162 circuit return conductors are connected to the second output terminal 122b via a pair of opposing diodes 130b and 132b, and the ground conductor 170 is connected to the third output terminal 124b.

The third 102c and fourth 102d plug connectors are connected analogously to the first 102a and the second 102b plug connectors. One supply conductor 154 is connected to the first output terminal 120c of the third plug connector 102c and the remaining supply conductor 156 is connected to the first output terminal 120d of the fourth plug connector 102d. Furthermore, the first 160 and the second 162 circuit return conductors are connected to the second output terminals 122c and 122d of the third 102c and the fourth 102d plug connectors via pairs of opposing diodes 130c, 132c and 130d, 132d, respectively. The ground conductor 170 is connected to the third output terminals 124c and 124d of the third 102c and fourth 102d plug connectors, respectively.

Optionally, the wiring harness 100 may comprise a plurality of supply conductors and plug connectors, each plug connector having a first, a second and a third output terminal as well as a pair of diodes. The connections of these plug connectors are analogous to the connections of the first, second, third and fourth plug connectors described above.

In FIG. 1, the first output terminals 120a-d and the second output terminals 122a-d are connected to a respective solenoid valve 110a-d. Furthermore, each of the output terminals 124a-d is connected to a protective ground of the solenoid valves 110a-d. According to the present embodiment, the solenoid valves 110a-d are utilized to inject air pulses into filter elements comprised in dust collectors, cf. the discussion in the background section.

In operation, an AC input signal is applied to the supply conductor 150 to drive the solenoid valve 110a. After passing through the solenoid, the positive portion of the AC waveform is allowed through one of the diodes, for example diode 130a, and will be blocked at the other diodes (130b,c,d, etc.) connected to return conductor (160). In a similar fashion, after passing through the solenoid, the negative portion of the AC waveform is allowed through the other diode (132a) and will be blocked at the other diodes (132b,c,d, etc.) connected to return conductor (162). Thereby, the AC current applied to supply conductor 150 is prevented from activating the other solenoids 110b-d, by means of the diodes 132b-d blocking current from flowing into these subcircuits via their connections to the circuit return conductors 160 and 162. In case of DC operation, only one diode, e.g. the diode 130a, will be present in the connector but the operation of the corresponding diodes 130b-d will be same as above, i.e. blocking current from flowing into the other subcircuits thereby preventing erroneous activation of the other solenoids 110b-d.

Similarly to the discussion above relating to the input signals provided to the supply conductor 150, input signals applied to the supply conductors 152, 154 and 156 will drive the solenoid valves 110b, 110c and 110d, respectively. Input signals may be applied to one or several supply conductors simultaneously. An input signal from one supply conductor may be synchronous or asynchronous with an input signal delivered from another supply conductor. Analogously to the above, the diodes 130a-d and 132a-d are arranged to lead current back through only one of the circuit return conductors 160 or 162 and, moreover, to prevent an undesired activation of solenoid valves 110b-d.

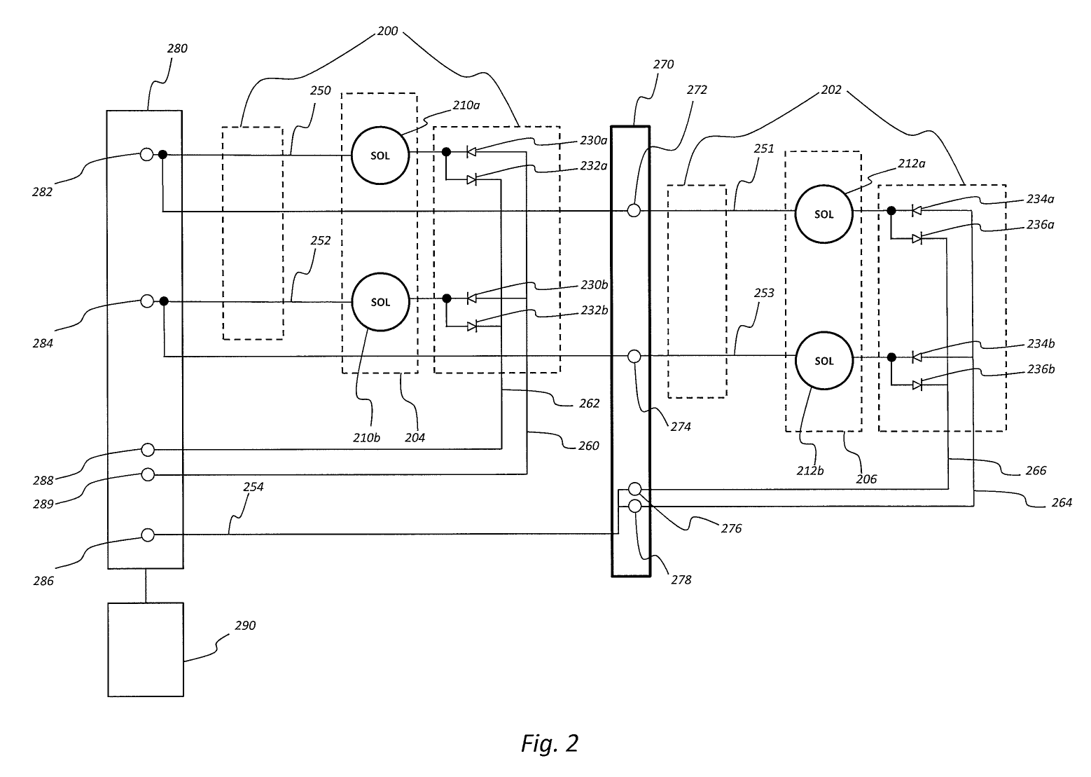

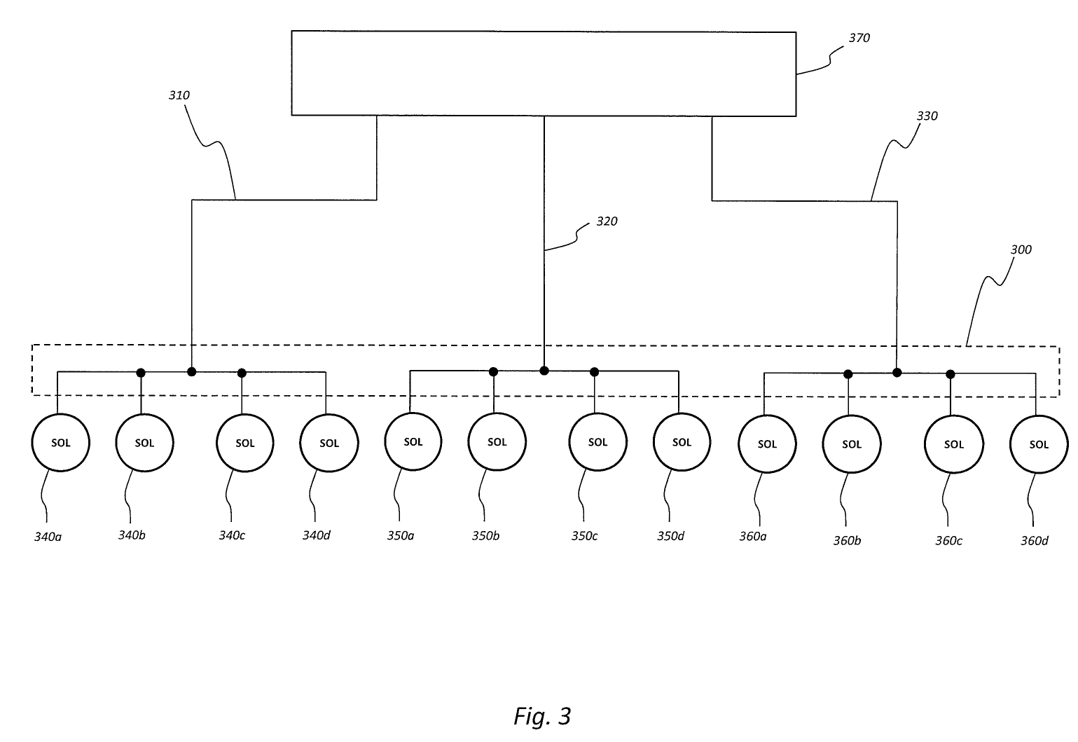

The wiring harness 100, comprising the supply conductors 150, 152, 154, 156, the circuit return conductors 160, 162 and the ground conductor 170 may preferably be connected to a control unit, or equivalently, a pulse control panel or a pulse timer board. The pulse control panel is configured to control the activation of the solenoid valves 110a-d by providing input signals to the supply conductors 150, 152, 154, 156 according to a predetermined scheme. Embodiments of connections to a pulse control panel are described in more detail below in relation to FIG. 2 and FIG. 3.

According to an alternative embodiment of the present inventive concept, the wiring harness comprises more than four plug connectors, e.g. 10 plug connectors, for controlling additional solenoid valves.

According to yet another embodiment, the output terminals of at least one plug connector is connected to more than one solenoid valve, or some additional electronic device. These solenoid valves and electronic devices may be coupled in series or in parallel.

FIG. 2 is a schematic wiring layout of a wiring circuit according to the present inventive concept, wherein two sets of wiring harnesses 200 and 202 are coupled to four solenoid valves 210a, 210b and 212a, 212b, respectively.

As opposed to FIG. 1, the plug connectors are suppressed in FIG. 2 for clarity. The first wiring harness 200 comprises two supply conductors 250 and 252 and two circuit return conductors 260 and 262. For clarity, a possible ground conductor of the circuit system and its connections is not shown in FIG. 2. The supply conductors 250 and 252 are connected to a solenoid valve 210a and 210b, respectively, comprised in a first compartment 204. Moreover, each solenoid valve 210a, 210b is connected to the circuit return conductors 260 and 262 via the diodes 230a, 230b and 232a, 232b, respectively. The diodes 230a and 230b are directed in the same directions with respect to the wiring 260 while the diodes 232a and 232b are directed in the same directions with respect to the wiring 262. Moreover, the diodes 230a, 230b are directed in opposite directions to the diodes 232a, 232b.

The second wiring harness 202 comprises two supply conductors 251 and 253, which are connected in parallel with the supply conductors 250 and 252, respectively. Moreover, the second wiring harness 202 comprises two circuit return conductors 264 and 266 which are joined and thereafter connected to a solenoid common conductor 254. The supply conductors 251 and 253 are connected to a solenoid valve 212a and 212b, respectively, comprised in a second compartment 206. Moreover, each solenoid valve 212a, 212b is connected to the circuit return conductors 264 and 266 via the diodes 234a, 234b and 236a, 236b, respectively. The diodes 234a and 234b are directed in the same directions with respect to the wiring 264 while the diodes 236a and 236b are directed in the same directions with respect to the wiring 266. Moreover, the diodes 234a, 234b are directed in opposite directions to the diodes 236a, 236b. A pulse control panel 280 provides input signals to the supply conductors 250 and 252, and the supply conductors 251 and 253, via the pulse output ports 282 and 284, respectively. Moreover, the pulse control panel 280 comprises return ports 286, 288, 289 for connecting to the solenoid return conductors 254, 260, 262.

The input signals are provided from a power supply device 290 connected to the pulse control panel 280. Optionally, the power supply device 290 provides pulses to a plurality of supply conductors, separately or in groups, and the pulse control panel 280 controls each of these pulses.

Input signals may be provided by the pulse control panel 280 to one or several supply conductors 250, 252 simultaneously.

An input signal provided at the pulse output port 282 to the supply conductors 250, 251 will drive the solenoid valve 210a and the solenoid valve 212a. Similarly, an input signal provided at the pulse output port 284 to the supply conductors 252, 253 will drive the solenoid valve 210b and the solenoid valve 212b. To summarize using a different terminology, a given input signal will drive one solenoid valve in each compartment 204, 206.

Optionally, the pulse control panel 280 provides input signals to the supply conductors according to a predetermined scheme. The predetermined scheme may be based on a time schedule, on the performance of the solenoid valves or electronic devices comprised in the circuit, on the spatial location of the electronic devices, on the resistance of the filter elements associated to the solenoid valves, etc.

According to an alternative embodiment, the wiring circuit comprises a plurality of wiring harnesses, each wiring harness being arranged to be connected to a compartment comprising a plurality of solenoid valves. In analogy with the embodiment related to FIG. 2, an input signal applied to one supply conductor in this wiring configuration will drive one solenoid valve in each compartment.

As described in the background section in relation to dust collectors, in one embodiment the solenoid valves may control the distribution of air pulses into filter elements for cleaning them. In this context, each solenoid valve 210a, 210b, 212a, 212b in FIG. 2 is associated to a filter element. As a result of the present inventive concept, an online cleaning of the filter elements may be undertaken by activating one solenoid valve in each compartment at a time, thereby cleaning the associated filter elements. The remaining solenoid valves in each of the compartments may then be left unactivated, letting the filter elements associated to these unactivated solenoid valves continue to collect pollutive elements from the streaming gas. At a later stage, filter elements associated to different solenoid valves may be cleaned in a similar manner. Thus, after a certain time period, all filter elements have been cleaned.

In accordance with an alternative embodiment of the present inventive concept, at least one compartment comprises more than two solenoid valves. Optionally, at least one compartment comprises additional electronic devices.

FIG. 3 is a schematic layout of a wiring circuit 300 according to the present inventive concept. The wiring circuit 300 comprising three wiring harnesses 310, 320 and 330, each of which is connected to four solenoid valves 340a-d, 350a-d and 360a-d, respectively.

Moreover, the three wiring harnesses 310, 320 and 330 are connected to a pulse control panel 370, the function of which has been described above in relation to the embodiment according to FIG. 2.

An embodiment of each of the wiring harnesses 310, 320, 330 has been described in relation to FIG. 1, which also depicts the connection of a wiring harness 100 to four solenoid valves 110a-d. According to one embodiment, the circuit return conductors 160 and 162 in FIG. 1 are joined into a solenoid common conductor, cf. the wirings 260, 262 and 254 in FIG. 2. Thus, analogously, according to one embodiment, each of the wiring harnesses 310, 320, 330 comprises only one, or possibly two, solenoid common conductors. This low number of wirings simplifies the wiring installation of the solenoid valves 340a-d, 350a-d and 360a-d.

To summarize, there is provided a wiring harness. The wiring harness comprises a first supply conductor, a first and a second circuit return conductor, and a first plug connector comprising a first and a second output terminal. The supply conductor is connected to the first output terminal. Moreover, the first circuit return conductor is connected to the second output terminal via a first diode arranged in the plug connector, and the second circuit return conductor is connected to the second output terminal via a second opposing diode arranged in the plug connector. There is also provided a wiring circuit comprising a plurality of wiring harnesses.

The invention has mainly been described above with reference to a few embodiments. However, as is readily appreciated by a person skilled in the art, other embodiments than the ones disclosed above are equally possible within the scope of the invention, as defined by the appended patent claims.

1. A wiring harness comprising:
a first supply conductor;
a first and a second circuit return conductor;
a first plug connector comprising a first and a second output terminal, wherein the supply conductor is connected to the first output terminal, and
the first circuit return conductor is connected to the second output terminal via a first diode arranged in said plug connector, and the second circuit return conductor is connected to the second output terminal via a second opposing diode arranged in said plug connector.

2. A wiring harness according to claim 1, further comprising a ground conductor.

3. A wiring harness according to claim 1, further comprising:
a second supply conductor;
a second plug connector comprising a first and a second output terminal,
wherein the second supply conductor is connected to the first output terminal of the second plug connector, and
wherein the first circuit return conductor is connected to the second output terminal of the second plug connector via a first diode arranged in the second plug connector, and the second circuit return conductor is connected to the second output terminal of the second plug connector via a second opposing diode arranged in the second plug connector.

4. A wiring harness according to claim 3, wherein the first supply conductor terminates at the first plug connector and wherein the second supply conductor passes through the first plug connector and terminates at the second plug connector.

5. A wiring harness according to claim 3, wherein the output terminals in each of the plug connectors are arranged to be connected to a respective electronic device.

6. A wiring harness according to claim 3, wherein the output terminals in each of the plug connectors are arranged to be connected to a respective solenoid valve electronic device.

7. A wiring circuit comprising:
a plurality of wiring harnesses according to claim 1,
wherein said plurality of harnesses are coupled in parallel such that the first supply conductor of each of said plurality of harnesses are jointly connected, the second supply conductor of each of said plurality of harnesses are jointly connected, and the circuit return conductors of each of said plurality of harnesses are jointly connected.

8. A wiring circuit according to claim 7 connected to a control unit for controlling a plurality of electronic devices.

9. A wiring circuit according to claim 7, wherein at least one of said plurality of electronic devices is a solenoid valve.

10. A wiring circuit according to claim 7 wherein the control unit is arranged to provide AC pulses according to a predetermined scheme on each of said supply conductors.
